(19) United States
(12) Patent Application Publication
(10) Pub. No.: US 2006/0115059 A1
(43) Pub. Date: Jun. 1, 2006

(54) Image-forming device

(75) Inventor: Hiroshi Nobe, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 11/265,168

(22) Filed: Nov. 3, 2005

(30) Foreign Application Priority Data
Nov. 30, 2004 (JP) 2004-347644

(51) Int. Cl. H04M 11/00

(52) U.S. Cl. 379/100.01

(57) ABSTRACT

An image-forming device includes an image-forming unit, a casing and a handset cradle. The image-forming unit that forms an image on a recording medium includes a process unit that has a consumable unit. The casing accommodates the process unit. The casing has a top surface, a bottom surface, at least one side surface connecting the top surface and the bottom surface, and a cover capable of opening and closing. The cover is provided at the side surface. The process unit is detachable from the casing when the cover is opened. The handset cradle that supports a handset is disposed on or above the top surface. The handset cradle and the casing are disposed in an overlapping relation in a vertical direction orthogonal to the bottom surface.

### BACKGROUND OF THE INVENTION

1. Field of the Invention

The present invention relates to an image-forming device having a telephone function.

2. Description of Related Art

A conventional multifunction device having facsimile, scanner, copier, and printer functions, such as that disclosed in Japanese unexamined patent application publication No. HEI-11-69046, generally includes an image-forming unit, and an image-reading unit disposed on top of the image-forming unit. A cover that is opened to mount or remove a process unit, and a handset are provided on the surface of the image-forming unit opposing the image-reading unit. Since this construction does not require additional space on the side of the image-forming unit or the like to provide the handset, the image-forming device can be made more compact.

However, in the multifunction device disclosed in Japanese unexamined patent application publication No. HEI-11-69046, the handset and cover are provided on the same surface of the device, thereby reducing the surface area of the cover by the area required for mounting the handset. Consequently, the space of the opening through which the process cartridge is mounted and removed is also smaller. Further, when the cover is provided on the surface of the image-forming unit facing the image-reading unit as described above, the image-reading unit gets in the way of the cover when the cover is being opened and closed, impeding the operation for mounting or removing the process cartridge.

### SUMMARY OF THE INVENTION

In view of the foregoing, it is an object of the present invention to provide an image-forming device that has at least a telephone function and that is constructed to facilitate mounting and removal operations of the process cartridge while enabling the device to be made more compact.

In order to attain the above and other objects, the present invention provides an image-forming device including an image-forming unit, a casing and a handset cradle. The image-forming unit that forms an image on a recording medium includes a process unit that has a consumable unit. The casing accommodates the process unit. The casing has a top surface, a bottom surface, at least one side surface connecting the top surface and the bottom surface, and a cover capable of opening and closing. The cover is provided at the side surface. The process unit is detachable from the casing when the cover is opened. The handset cradle that supports a handset is disposed on or above the top surface. The handset cradle and the casing are disposed in an overlapping relation in a vertical direction orthogonal to the bottom surface.

### BRIEF DESCRIPTION OF THE DRAWINGS

The above and other objects, features and advantages of the invention will become more apparent from reading the following description of the preferred embodiments taken in connection with the accompanying drawings in which:

FIG. 1 is a perspective view showing a multifunction device according to a preferred embodiment of the present invention;

FIG. 2 is a side cross-sectional view of the multifunction device in FIG. 1;

FIG. 3 is a perspective view of the multifunction device when a front cover is open;

FIG. 4 is a perspective view of the multifunction device when the front cover is open and a process unit has been removed;

FIG. 5 is a front view of the multifunction device;

FIG. 6 is a plan view of the multifunction device;

FIG. 7 is a side view of the multifunction device;

FIG. 8 is a perspective view of the multifunction device showing an internal structure thereof; and

FIG. 9 is a side view of a multifunction device according to a variation of the preferred embodiment.

### DETAILED DESCRIPTION OF THE PREFERRED EMBODIMENTS

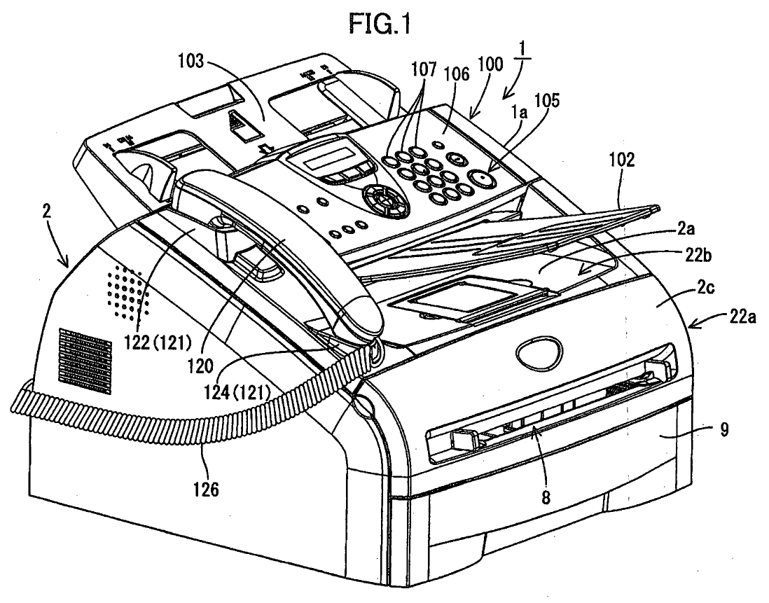

An image-forming device according to a preferred embodiment of the present invention will be described while referring to FIGS. 1 through 8.

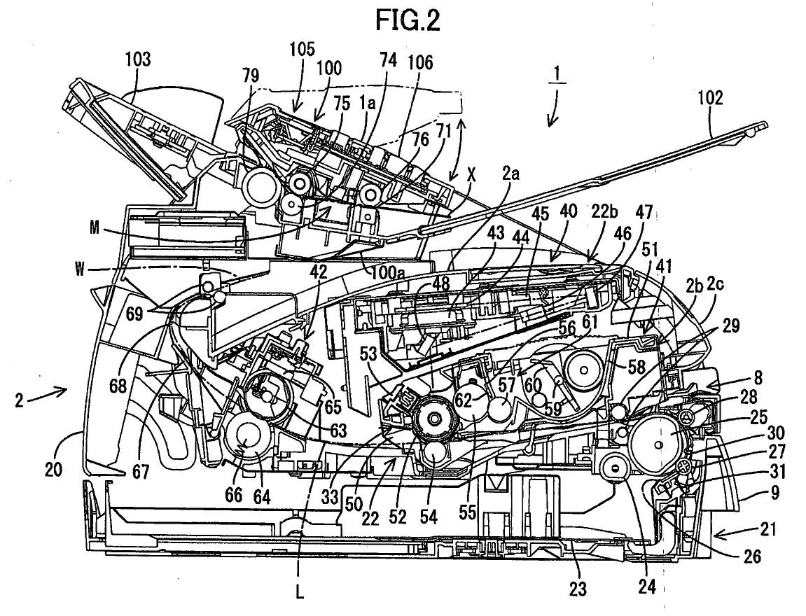

The image-forming device according to the preferred embodiment is a multifunction device 1 having a printer function, telephone function, facsimile function, and the like. FIG. 1 is a perspective view of the multifunction device 1 according to the preferred embodiment. As shown in FIG. 1, the multifunction device 1 has a main device body 1a that accommodates a recording unit 2 and a reading unit 100. The recording unit 2 accommodates a feeder unit 21 and an image-forming unit 22 (both shown in FIG. 2) and includes a discharge tray 2a provided on the top surface thereof. The reading unit 100 is disposed on top of the recording unit 2 leaving a space above the discharge tray 2a.

In the preferred embodiment, “process unit” indicates a module including integrated parts used for image formation. The process unit includes at least one consumable unit used for forming images according to an electrophotographic process, such as an image-carrying member; a developing roller or other developing means; a paper dust-removing device, toner recovery device, or other cleaning means; and a Scorotron charger or other charging means. The following description includes one example of such a process unit.

In the following description, the “vertical direction” is the vertical direction with respect to the multifunction device 1 when the multifunction device 1 is placed on a level surface, so that “up” is upward in the vertical direction and “down” is downward in the vertical direction. Further, the “latitudinal direction” is a direction orthogonal to the vertical direction and orthogonal to a direction in which the paper is conveyed. Further, the “front-to-right direction” is a direction orthogonal to both the vertical direction and the latitudinal direction, so that the “front” refers to the side of the multifunction device 1 on which a cover 2c described later is provided and the “rear” is the side opposite the front side. The following description conforms to these definitions.

Next, the structure of the recording unit 2 will be described with reference to FIG. 2. FIG. 2 is a side cross-sectional view of the multifunction device 1 in a direction following an axis of a feeding roller 25 and the like. In FIG. 2, the multifunction device 1 is oriented with the front side facing rightward and the rear side facing leftward.

The recording unit 2 is configured of a casing 20 that accommodates the feeder unit 21 for supplying paper into the image-forming unit 22, the image-forming unit 22 for forming prescribed images on the paper supplied from the feeder unit 21, and the like. The discharge tray 2a is disposed above the image-forming unit 22 for receiving and maintaining paper discharged from the image-forming unit 22 after the image-forming unit 22 has formed an image thereon.

The feeder unit 21 includes a paper cassette 9, a paper-pressing plate 23, a pickup roller 24, the feeding roller 25, a separating pad 26, a pinch roller 27, a paper dust roller 28, a pair of registration rollers 29, and a guide member 30. The guide member 30 forms an arc shape following the periphery of the feeding roller 25.

Paper supplied in a forward direction from the front end of the paper cassette 9 is guided along the guide member 30 by the pickup roller 24, feeding roller 25, and pinch roller 27 and is thereby redirected toward the rear of the multifunction device 1 and conveyed to the image-forming unit 22 disposed above the paper cassette 9.

The paper cassette 9 is detachably mounted in a lower section of the casing 20 and accommodates a plurality of sheets of paper stacked therein. The paper cassette 9 can be pulled out of the multifunction device 1 through the front side thereof in order to load more paper therein. When the paper cassette 9 is pulled out of the multifunction device 1, the feeder unit 21 separates at a point between the feeding roller 25 and the separating pad 2.6. More specifically, the pinch roller 27, separating pad 26, and a spring 31 disposed on the underside of the separating pad 26 are pulled out together with the paper cassette 9.

The end of the paper-pressing plate 23 farthest from the feeding roller 25 (the rear end) is pivotably supported in the paper cassette 9 so that the end nearest the feeding roller 25 (the front end) can move vertically.

The pickup roller 24 is positioned above the front end of the paper cassette 9 so as to contact the topmost sheet of the paper stacked in the paper cassette 9. The pickup roller 24 functions to pick up and feed the paper to a position from where the feeding roller 25 can convey the paper (between the feeding roller 25 and separating pad 26).

The separating pad 26 is disposed in confrontation with the feeding roller 25. The spring 31 disposed on the underside of the separating pad 26 presses the separating pad 26 toward the feeding roller 25. The separating pad 26 functions to prevent a plurality of overlapped sheets of the paper from being supplied onto the conveying path indicated by the broken line L in FIG. 2.

Hence, the paper that is picked up by the pickup roller 24 comes into contact with the feeding roller 25 and separating pad 26. At this time, the separating pad 26 applies a suitable frictional force to the paper so as to restrict all but the topmost sheet of paper when the pickup roller 24 feeds a plurality of sheets to the separating pad 26. As a result, the feeding roller 25 can feed the paper one sheet at a time. In FIG. 2, the reference numeral W signifies only paper being discharged from the multifunction device 1. Paper being conveyed through the multifunction device 1 and paper accommodated in the paper cassette 9 are not shown in FIG. 2.

The feeding roller 25 conveys the paper in cooperation with the pinch roller 27 opposing the feeding roller 25 so that the paper changes direction by about 180° and is conveyed to the registration rollers 29. Before the paper reaches the registration rollers 29, the paper dust roller 28 removes paper dust from the paper.

The pair of registration rollers 29 function to correct misalignment in the paper conveyed along the paper-conveying path. This is accomplished with a position sensor (not shown) disposed near the feeding roller 25 for detecting the paper, and a control system (not shown) for controlling when the registration rollers 29 are driven and halted based on a detection timing of the position sensor.

Specifically, the control system drives the registration rollers 29 while the image sensor has not detected a leading edge of the paper being conveyed by the feeding roller 25, and halts the registration rollers 29 when the position sensor detects the leading edge of the paper. After the paper contacts the registration rollers 29 and becomes slack, the control device begins driving the registration rollers 29 again in order to convey the paper to the image-forming unit 22.

A manual feed opening 8 is formed in the front side of the multifunction device 1 slightly above the feeding roller 25 so that paper can be directly fed through the front of the multifunction device 1 to the registration rollers 29. Hence, the paper can be supplied onto the conveying path without being loaded in the paper cassette 9.

The image-forming unit 22 has a front surface part 22a and a top surface part 22b and accommodates a scanning unit 40, a process unit 41, a fixing unit 42, and the like. The scanning unit 40 is disposed in a top section of the casing 20 and includes a laser light-emitting unit (not shown), a polygon mirror 44 that is rotatably disposed, a polygon motor 43 for driving the polygon mirror 44 to rotate, lenses 45 and 46, and reflecting mirrors 47 and 48. The laser light-emitting unit emits a laser beam based on prescribed image data. The laser beam passes through or is reflected by the polygon mirror 44, lens 45, reflecting mirror 47, lens 46, and reflecting mirror 48 in the order given along a path indicated by alternating dots and dashes in FIG. 2. The laser beam is irradiated in a high-speed scan over the surface of a photosensitive drum 52 in the process unit 41 described later.

An accommodating section 2b is formed in the recording unit 2 below the discharge tray 2a for accommodating the process unit 41. The accommodating section 2b is open on the front side of the casing 20. The cover 2c is provided so as to be able to open and close over this opening in the accommodating section 2b. By opening the cover 2c, the process unit 41 can be mounted in or removed from the main body of the recording unit 2.

The process unit 41 includes a drum cartridge 50, and a developer cartridge 51. A space is formed between the process unit 41 and the scanning unit 40.

The drum cartridge 50 includes the photosensitive drum 52, a Scorotron charger 53, a transfer roller 54, and a paper dust-removing device 33. The developer cartridge 51 includes a developing roller 55, a thickness-regulating blade 56, a toner supply roller 57, and a toner box 58. The developer cartridge 51 is detachably mounted on the drum cartridge 50.

A rotational shaft 59 is disposed in the center of the toner box 58. An agitator 60 is supported on the rotational shaft 59 and is capable of rotating in a direction indicated by the arrow (clockwise in FIG. 2). A toner supply opening 61 is formed in the rear side of the toner box 58. The agitator 60 stirs the toner in the toner box 58, discharging some of the toner through the toner supply opening 61.

The toner supply roller 57 is disposed on the rear side of the toner supply opening 61 and is capable of rotating counterclockwise in FIG. 2. The developing roller 55 is disposed in confrontation with the toner supply roller 57 and is also capable of rotating in the counterclockwise direction. The toner supply roller 57 and developing roller 55 contact each other with pressure so that each is compressed to a degree.

The toner supply roller 57 is configured of a metal roller shaft covered by a roller that is formed of an electrically conductive foam material. The developing roller 55 is configured of a metal roller shaft covered by a roller that is formed of an electrically conductive rubber material having no magnetic properties. More specifically, the roller portion of the developing roller 55 is formed of an electrically conductive urethane rubber or silicon rubber including fine carbon particles or the like, the surface of which is coated with a urethane rubber or silicon rubber including fluorine. During a developing operation, a developing bias is applied to the developing roller 55.

The thickness-regulating blade 56 is disposed near the developing roller 55. The thickness-regulating blade 56 is configured of a main blade member formed of a metal leaf spring member, and a pressing part 62 provided on the distal end of the main blade member. The pressing part 62 has a semicircular cross-section and is formed of an insulating silicon rubber. The thickness-regulating blade 56 is supported on the developer cartridge 51 so that the elastic force of the main blade member causes the pressing part 62 to contact the developing roller 55 with pressure.

Toner discharged through the toner supply opening 61 by the rotation of the agitator 60 is supplied onto the developing roller 55 by the rotation of the toner supply roller 57. At this time, the toner is positively tribocharged between the toner supply roller 57 and developing roller 55. As the developing roller 55 continues to rotate, the toner supplied onto the surface of the developing roller 55 passes between the pressing part 62 of the thickness-regulating blade 56 and the developing roller 55, at which the toner is further tribocharged and is smoothed so that a thin layer of uniform thickness is carried on the developing roller 55.

The photosensitive drum 52 is disposed at a position on the rear side of the developing roller 55 and is capable of rotating clockwise in FIG. 2 while in confrontation with the developing roller 55. The photosensitive drum 52 includes a main drum body that is grounded, and a surface layer formed of a positive-charging photosensitive layer of polycarbonate or the like. A main motor (not shown) generates a motive force for driving the photosensitive drum 52 to rotate.

The charger 53 is disposed in opposition to the photosensitive drum 52 but separated a prescribed distance therefrom and is positioned about 30° above the horizontal along a radial direction of the photosensitive drum 52. The charger 53 is a positive-charging Scorotron charger having a charging wire formed of tungsten or the like from which a corona discharge is generated. The charger 53 functions to charge the entire surface of the photosensitive drum 52 with a uniform positive polarity.

As the photosensitive drum 52 rotates, the charger 53 charges the surface of the photosensitive drum 52 with a uniform positive polarity. Subsequently, the scanning unit 40 irradiates a laser beam in a high-speed scan to form an electrostatic latent image on the surface of the photosensitive drum 52 based on prescribed image data.

Next, positively charged toner carried on the surface of the developing roller 55 comes into contact with the photosensitive drum 52 as the developing roller 55 rotates and is supplied to areas on the surface of the positively charged photosensitive drum 52 that were exposed to the laser beam and, therefore, have a lower potential. In this way, the latent image on the photosensitive drum 52 is developed into a visible image according to a reverse development process.

The transfer roller 54 is rotatably supported in the drum cartridge 50 at a position below the photosensitive drum 52. The transfer roller 54 is capable of rotating in the counterclockwise direction of FIG. 2 while in confrontation with the photosensitive drum 52. The transfer roller 54 is configured of a metal roller shaft covered by a roller that is formed of a rubber material with ionic conductivity. A forward transfer bias is applied to the transfer roller 54 during a transfer operation. As a consequence, the visible image carried on the surface of the photosensitive drum 52 is transferred onto the paper as the paper passes between the photosensitive drum 52 and transfer roller 54. The paper dust-removing device 33 includes a brush member that is placed in confrontation with the photosensitive drum 52. After a toner image has been transferred, the paper dust-removing device 33 removes any paper dust that has been deposited on the surface of the photosensitive drum 52.

The fixing unit 42 is disposed downstream of the process unit 41 in the paper-conveying direction (rearward). The fixing unit 42 includes a fixing roller 63 on which a gear is formed, a pressure roller 64 that contacts the fixing roller 63 with pressure, and a thermostat 65.

The fixing roller 63 is formed of metal and accommodates a halogen lamp for generating heat. Springs 66 are provided on the underside of the pressure roller 64 for pressing the pressure roller 64 toward a rotational axis of the fixing roller 63 so that the pressure roller 64 is in close contact with the fixing roller 63 or the paper. The pressure roller 64 rotates in synchronization with the fixing roller 63.

The thermostat 65 is a bi-metal thermostat, for example, that functions to turn the power of the heater for heating the fixing roller 63 on and off in response to heat generated from the fixing roller 63. In this way, the thermostat 65 prevents the fixing roller 63 from being heated to an abnormally high temperature.

In the fixing unit 42 having this construction, toner transferred onto a sheet of paper in the process unit 41 is fixed by heat generated in the fixing roller 63 and pressure provided by the pressure roller 64 as the paper passes between the fixing roller 63 and pressure roller 64. After the fixing process, the fixing roller 63 conveys the paper along a discharge path leading to the discharge tray 2a on the top surface of the recording unit 2. The discharge path is formed by guide members 67 and 68. A pair of discharge rollers 69 is disposed at the top of the discharge path for discharging the paper onto the discharge tray 2a.

The reading unit 100 is disposed above the image-forming unit 22, and more specifically above the discharge tray 2a of the recording unit 2, so that a bottom surface 100a of the reading unit 100 opposes and covers the discharge tray 2a.

As shown in FIG. 2, the reading unit 100 includes a document-feeding tray 103, a document discharge tray 102, and a document-conveying path M along which an original X loaded in the document-feeding tray 103 is guided from the document-feeding tray 103 to the document discharge tray 102. A compact image sensor (CIS) 71 is disposed along the document-conveying path M so as to oppose the original x being conveyed along the document-conveying path M by a drive mechanism. In FIG. 2, the reference numeral X indicates only an original document that has been discharged.

A document pickup roller 79 is disposed on the upstream end of the document-conveying path M with respect to the document-conveying direction for guiding the original X loaded in the document-feeding tray 103 along the document-conveying path M one sheet at a time. A feeding roller 74 and a pinch roller 75 are disposed in confrontation with each other on the document-conveying path M downstream of the document pickup roller 79. The feeding roller 74 is positioned to contact the bottom surface of the original, while the pinch roller 75 is disposed on the bottom surface side of an upper reading unit 105. When the upper reading unit 105 is closed (rotated downward) the pinch roller 75 presses against the top of the feeding roller 74. A pressure roller 76 is also provided along the document-conveying path M at a position opposing the CIS 71 for pressing the original against the CIS 71 as the original passes through this region.

The CIS 71 is a line-type sensor that extends in a direction orthogonal to the conveying direction of the original X (a direction orthogonal to the surface of the drawing in FIG. 2). The CIS 71 includes a plurality of photodiodes (not shown) aligned in the extended direction of the CIS 71, and a light source (not shown) for projecting an intense light onto the original X. The light reflected off the original is received by the photodiodes, and the light intensity (brightness) of the reflected light for each pixel in the original X is converted into electric signals. The reading unit 100 includes an A/D converter (not shown) for converting these electric signals to digital data, enabling an image formed on the original X to be read as image data.

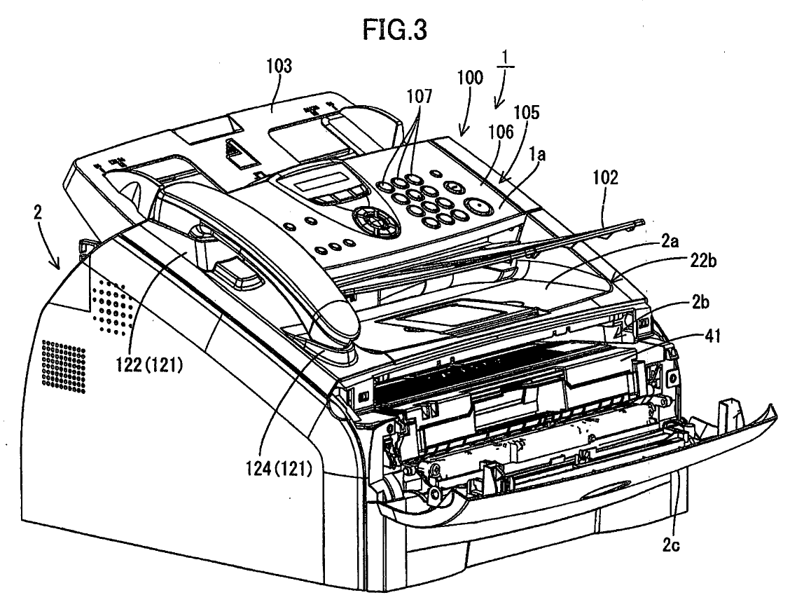

The upper reading unit 105 disposed on the top side of the reading unit 100 is provided with numerical keys 107 (FIG. 3), and a control panel 106 having various function keys and the like. These keys are pressed to perform various operations that are executed by the reading unit 100.

In the preferred embodiment, operations for mounting and removing the paper cassette 9, mounting and removing the process unit 41, retrieving paper discharged onto the discharge tray 2a, and retrieving original documents discharged onto the document discharge tray 102 are all performed on the front side of the multifunction device 1 in the main device body 1a. Enabling the user to access the paper cassette 9, process unit 41, paper, and original documents all on the same side greatly improves operability.

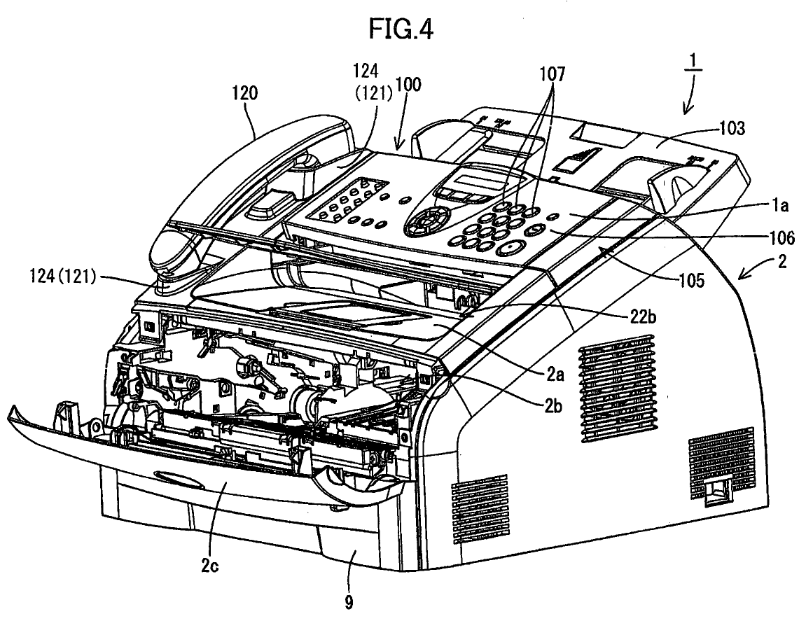

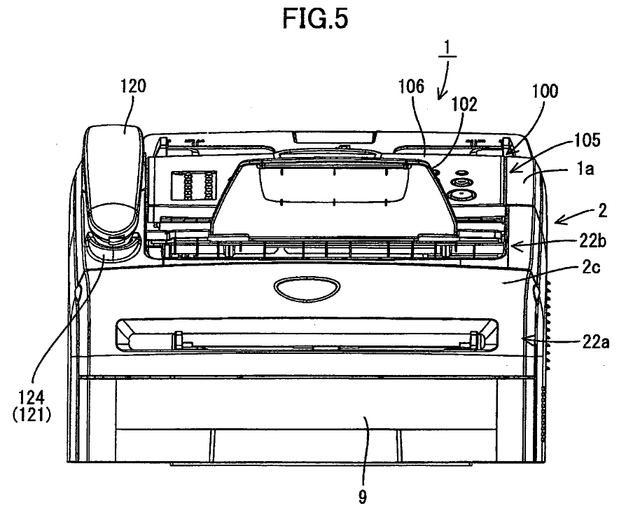

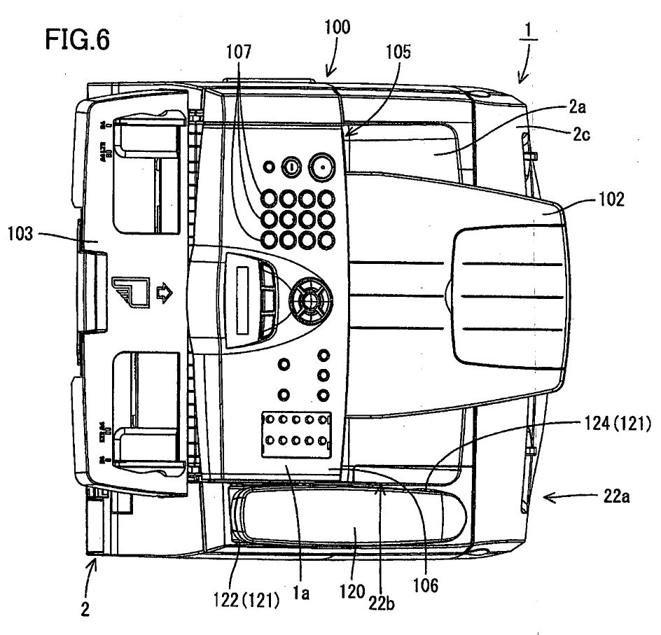

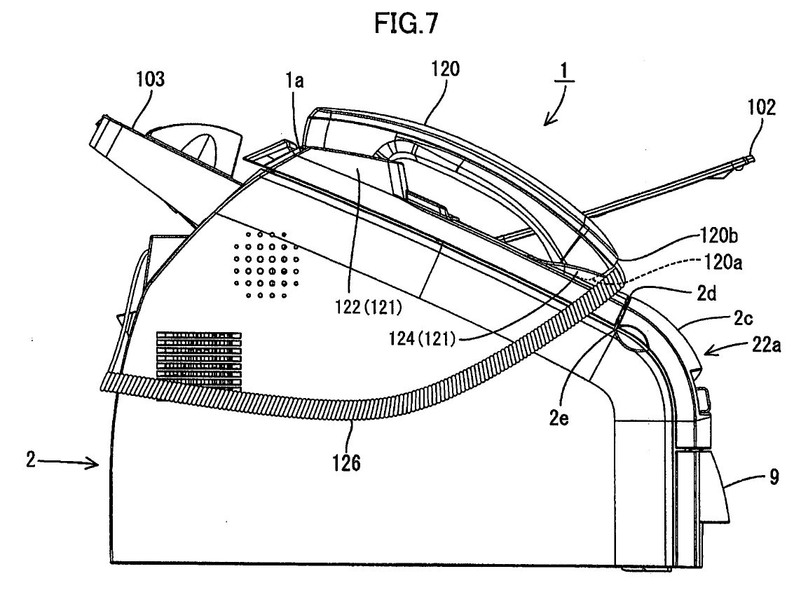

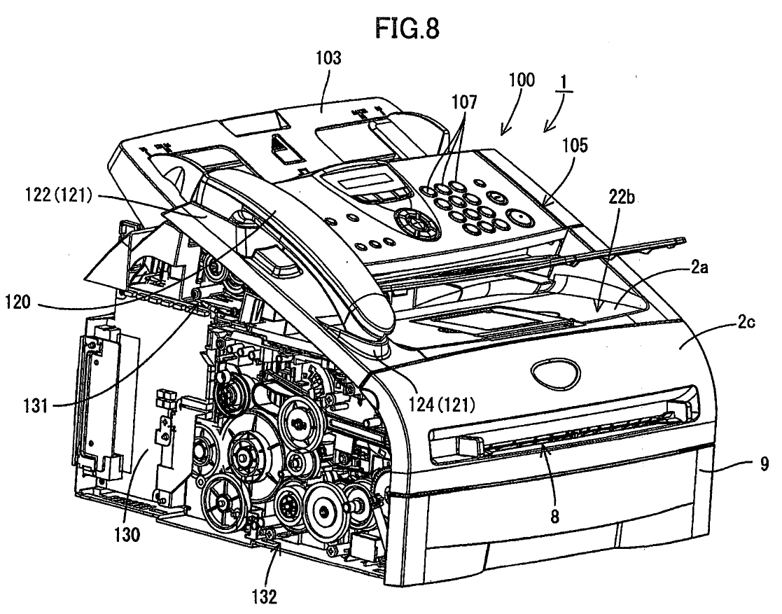

Next, the structure of a handset cradle will be described with reference to FIGS. 3 through 8. FIG. 3 is a perspective view showing the multifunction device 1 when the cover 2c is in an open state. FIG. 4 is a perspective view showing the multifunction device 1 when the cover 2c is open and the process unit 41 has been removed. FIG. 5 is a front view of the multifunction device 1. FIG. 6 is a plan view of the multifunction device 1. FIG. 7 is side view of the multifunction device 1. FIG. 8 is a perspective view showing the internal structure of the multifunction device 1. Note that the coil cord for the handset has been omitted from FIGS. 3, 4, 5, 6, and 8.

The cover 2c in the preferred embodiment can open and close at the front surface 22a (FIG. 5) of the recording unit 2 for exposing or covering the accommodating section 2b in which the process unit is provided. Since the cover 2c is provided on the front surface 22a of the recording unit 2 in this construction, a larger area can be allocated for the cover 2c. As shown in the front view of FIG. 5 and the plan view of FIG. 6, a handset cradle 121 is provided on top of the recording unit 2. A handset 120 can be rested in the handset cradle 121. As shown in FIG. 7, the handset cradle 121 is configured of an upper cradle part 122 and a lower cradle part 124 that overlap the recording unit 2 vertically.

In other words, the handset cradle 121 is provided on the top of the recording unit 2 so that the area occupied by the handset cradle 121 overlaps the area occupied by the recording unit 2 in the vertical direction. With this construction, the overall device can be made more compact in a direction orthogonal to the vertical direction, such as the latitudinal direction. Further, since the cover 2c is provided across nearly the entire width of the front surface part 22a of the image-forming unit 22, the overall device can be made more compact while ensuring more area for providing the cover 2c.

Specially, the handset cradle 121 is provided within the vertical boundaries of the recording unit 2, that is, the handset cradle 121 falls within the area occupied by the recording unit 2 when viewed in a plan view. Accordingly, the handset cradle 121 does not protrude from the recording unit 2 in the front, rear, left, or right direction, enabling the overall device to be made more compact. The handset 120 also falls within the region occupied by the recording unit 2 in the vertical direction when the handset 120 is mounted in the handset cradle 121.

As shown in FIGS. 5 and 6, the handset cradle 121 is disposed on one latitudinal side of the multifunction device 1 on the top surface of the main device body 1a. The reading unit 100 is provided in a region on the top surface of the main device body 1a outside of the region that the handset cradle 121 is provided. Consequently, the reading unit 100 and handset cradle 121 are efficiently arranged on the top surface of the main device body 1a.

As shown in FIG. 7, the handset 120 has a lower end part 120a and a front end part 120b. The cover 2c has a top end part 2d and a rear end part 2e. The handset 120 is mounted in the handset cradle 121 so that the lower end part 120a of the handset 120 is positioned above the top end part 2d of the cover 2c with respect to the vertical direction, while the front end part 120b of the handset 120 is positioned rearward of the rear end part 2e of the cover 2c with respect to the front-to-rear direction. A coil cord 126 extends from one end of the handset 120.

As shown in FIG. 7, one end of the coil cord 126 is connected to the handset 120 near the lower end thereof, while the other end is connected to the rear end of the main device body 1a. The coil cord 126 spans between the handset 120 and the main device body 1a with a suitable pulling force without contacting with the ground on which the image-forming device 1 is placed, when the handset 120 is mounted in the handset cradle 121.

This construction makes it difficult to extend the coil cord 126 in front of the handset 120, preventing the coil cord 126 from interfering with the cover 2c provided in front of the handset 120. Specifically, this construction prevents the coil cord 126 from being caught in the cover 2c when closing the cover 2c. The handset 120 is further prevented from interfering with the cover 2c by providing a suitable distance between the handset 120 and the top end of the cover 2c with respect to the vertical.

As shown in FIG. 8, a drive transfer mechanism 131 (shown partially in FIG. 8) is disposed below the handset cradle 121 for transferring a driving force from a motor (not shown) for the reading unit 100 to various components provided for reading images (the document pickup roller 79, pinch roller 75, feeding roller 74, pressure roller 76, etc.). The drive transfer mechanism 131 includes various gears or other transferring means for transmitting the driving force to the document pickup roller 79, pinch roller 75, feeding roller 74, and pressure roller 76.

A drive transfer mechanism 132 is also disposed below the handset cradle 121 for transferring a driving force from a motor for the recording unit 2 to various components of the recording unit 2 (the photosensitive drum 52, transfer roller 54, registration roller 29, developing roller 55, toner supply roller 57, etc.). This construction efficiently uses the space below the handset cradle 121. The drive transfer mechanism 132 includes various gears or other transferring mechanisms for transmitting the drive force to the photosensitive drum 52, transfer roller 54, registration roller 29, developing roller 55, toner supply roller 57, and the like.

A control circuit board 130 is also provided below the handset cradle 121 for electrically controlling the recording unit 2, thereby further efficiently using the space below the handset cradle 121. In the preferred embodiment, the control circuit board 130 is configured of a high voltage circuit board capable of producing high voltages used by the charger 53 and the like, but is not limited to this configuration. For example, the control circuit board may be configured of a low voltage circuit board for generating at least a constant low voltage, such as 24 V, or may be configured with an ASIC, various storage devices, and the like for controlling the components in the recording unit 2.

In the multifunction device 1 according to the preferred embodiment, the recording unit 2 has the top surface part 22b. The discharge tray 2a for receiving discharged paper is disposed on the top surface part 22b of the recording unit 2, facing the reading unit 100. Since the cover 2c is provided on the front surface of the recording unit 2, as described above, paper discharged after image formation can be stacked in a prescribed position, without the discharged paper or the discharge tray 2a interfering with the opening and the closing operation of the cover 2c.

In the preferred embodiment, the document discharge tray 102 is provided in the reading unit 100 for receiving documents that have been discharged after image reading. Since the cover 2c is provided on the front surface of the recording unit 2 as described above, documents discharged after image reading can be stacked in a prescribed position, without the discharge documents or the document discharge tray 102 interfering with the opening and closing operation of the cover 2c. More specifically, the discharge tray 2a is provided on the top surface part 22b of the recording unit 2, and the document discharge tray 102 is provided at a position above the discharge tray 2a. In other words, the image-forming unit 22, discharge tray 2a, and document discharge tray 102 are stacked in a vertical arrangement.

In order to improve operability, the control panel 106 is provided on the top surface of the reading unit 100. On the other hand, the cover 2c is provided on the top surface of the recording unit 2. Accordingly, the control panel 106 and the cover 2c are not likely to interfere with each other.

The upper reading unit 105 for covering the top of the document-conveying path M is capable of rotating open and closed over the document-conveying path M about a rotational shaft (not shown) as indicated by the broken line of alternating dashes and double dots in FIG. 2. Hence, the upper reading unit 105 forms the top wall of the document-conveying path M and opens and closes about a shaft extending in the latitudinal direction. Since the cover 2c is provided on the front surface of the recording unit 2, as described above, opening and closing operations of the cover 2c do not interfere with opening and closing operations of the upper reading unit 105.

While the invention has been described in detail with reference to specific embodiments thereof, it would be apparent to those skilled in the art that many modifications and variations may be made therein without departing from the spirit of the invention, the scope of which is defined by the attached claims.

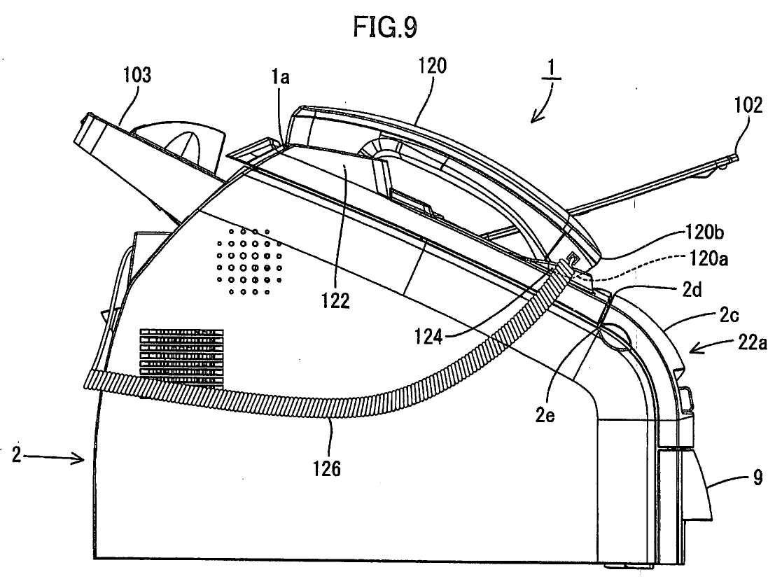

In the preferred embodiment described above, the coil cord 126 is connected to a longitudinal end of the handset 120. However, the coil cord 126 may be connected to a side of the coil cord 126 (the external side in the latitudinal direction), as shown in FIG. 9. This construction can further prevent interference between the coil cord 126 and the cover 2c.

In the preferred embodiment described above, the image-forming device adopts an electrophotographic process. However, another process may be used in order to form an image. For example, the image-forming device may adopt an inkjet process or heat-transferring ribbon process. When the inkjet process is adopted, the process unit includes at least an ink tank. When the heat-transferring ribbon process is adopted, the process unit includes at least a ribbon cartridge having an ink ribbon

What is claimed is:

1. An image-forming device comprising:
an image-forming unit that forms an image on a recording medium, the image-forming unit including a process unit that has a consumable unit;
a casing accommodating the process unit, the casing having a top surface, a bottom surface, at least one side surface connecting the top surface and the bottom surface, and a cover capable of opening and closing, the cover being provided at the side surface, wherein the process unit is detachable from the casing when the cover is opened; and
a handset cradle that supports a handset, the handset cradle being disposed on or above the top surface, wherein the handset cradle and the casing are disposed in an overlapping relation in a vertical direction orthogonal to the bottom surface.

2. The image-forming device according to claim 1, wherein the image-forming unit forms the image using an electrophotographic process.

3. The image-forming device according to claim 1, wherein a region of the handset cradle falls in a region of the casing in the vertical direction.

4. The image-forming device according to claim 1, wherein the cover is provided along an entire width of the side surface.

5. The image-forming device according to claim 1, further comprising a discharge tray that receives the recording medium discharged outside the casing after an image has been formed on the recording medium, the discharge tray being disposed on or above the top surface.

6. The image-forming device according to claim 1, further comprising an image-reading unit that reads an image from an original document, the image-reading unit being disposed on or above the top surface.

7. The image-forming device according to claim 6, further comprising a discharge tray that receives the recording medium discharged outside the casing after an image has been formed on the recording medium, the discharge tray being disposed on or above the top surface, wherein the image-reading unit is opposed to the discharge tray.

8. The image-forming device according to claim 6, wherein the image-reading unit includes a document tray that receives the original documents discharged from the image-reading unit after an image has been read by the image-reading unit, the document tray being disposed on or above the top surface.

9. The image-forming device according to claim 8, further comprising a discharge tray that receives the recording medium discharged outside the casing after an image has been formed on the recording medium, the discharge tray being disposed on or above the top surface, wherein the document tray is disposed in a position above the discharge tray.

10. The image-forming device according to claim 9, further comprising a recording medium cassette that accommodates recording mediums, the recording medium cassette being detachably provided in the casing, wherein operations for mounting and removing the recording medium cassette, mounting and removing the process unit, retrieving the recording medium discharged from the discharge tray, and retrieving an original document discharged from the document tray are all performed on a same side of the casing.

11. The image-forming device according to claim 6, further comprising a control panel via which operations for forming an image are inputted, the control panel being disposed on or above a top surface of the image-reading unit.

12. The image-forming device according to claim 6, wherein the image-reading unit includes an upper reading unit and a lower reading unit, a document-conveying path along which a document is conveyed is formed between the upper reading unit and the lower reading unit, wherein the upper reading unit is capable of opening in order to expose the document-conveying path.

13. The image-forming device according to claim 6, wherein the top surface has a first region and a second region, the first region and the second region are arranged in a widthwise direction of the top surface, wherein the handset cradle is disposed on or above the first region while the image-reading unit is disposed on or above the second region.

14. The image-forming device according to claim 13, further comprising:
a first driving unit that generates driving force for driving the image-forming unit, and
a first drive transfer mechanism that transfers the driving force from the first driving unit to the image-forming unit,
wherein the casing has a first space corresponding to the first region in the vertical direction and a second space corresponding to the second region in the vertical direction, wherein the first driving unit and the first drive transfer mechanism are disposed within the first space.

15. The image-forming device according to claim 13, further comprising:
a second driving unit that generates driving force for driving the image-reading unit, and
a second drive transfer mechanism that transfers the driving force from the second driving unit to the image-reading unit,
wherein the casing has a first space corresponding to the first region in the vertical direction and a second space corresponding to the second region in the vertical direction, wherein the second driving unit and the second drive transfer mechanism are disposed within the first space.

16. The image-forming device according to claim 13, further comprising a control circuit board that electrically controls the image-forming unit, wherein the casing has a first space corresponding to the first region in the vertical direction and a second space corresponding to the second region in the vertical direction, and the control circuit board is disposed within the first space.

17. The image-forming device according to claim 1, further comprising:
a handset that is supported by the handset cradle; and
a coil cord having a first end connected to the handset and a second end connected to the casing, and spanning between the handset and the casing,
wherein a portion of the handset closest to the cover is positioned above a top end of the cover.

18. The image-forming device according to claim 1, further comprising:
a handset that is supported by the handset cradle; and
a coil cord having a first end connected to the handset and a second end connected to the casing, and spanning the handset and the casing,
wherein the cover opens frontwardly, and a portion of the handset closest to the cover is positioned rearwardly of a portion of the cover closest to the handset.

19. The image-forming device according to claim 1, further comprising:
a handset that is supported by the handset cradle; and
a coil cord having a first end connected to the handset and a second end connected to the casing,
wherein the casing further includes second side surface adjacent to the side surface, and the first end is connected to a portion of the handset that is opposed to the second side surface.
